(19) United States
(12) Patent Application Publication
(10) Pub. No.: US 2021/0057114 A1
(43) Pub. Date: Feb. 25, 2021

(54) CRITICAL HEAT FLUX (CHF) ENHANCING SURFACE TREATMENT

(71) Applicant: Massachusetts Institute of Technology, Cambridge, MA (US)

(72) Inventors: Evelyn Wang, Cambridge, MA (US); Matteo Bucci, Boston, MA (US); Olorunsola Akinsulire, Jamaica, NY (US); Bren Phillips, Upton, MA (US); Youngsup Song, Cambridge, MA (US); Chi Wang, Cambridge, MA (US); Guanyu Su, Watertown, MA (US); Md Mahamudur Rahman, El Paso, TX (US)

(73) Assignee: Massachusetts Institute of Technology, Cambridge, MA (US)

(21) Appl. No.: 16/993,207

(22) Filed: Aug. 13, 2020

Related U.S. Application Data
(60) Provisional application No. 62/888,335, filed on Aug. 16, 2019.

(51) Int. Cl. G21C 3/08; G21C 15/25

(52) U.S. Cl. CPC G21C 3/08; G21C 15/25

(57) ABSTRACT

Engineered surfaces, such as surfaces having nano- and/or micro-scale features, may provide an enhanced flow boiling Critical Heat Flux (CHF) at ambient or higher pressures, which may enhance cooling. Enhancing flow boiling CHF may be desirable for nuclear reactors, where heat is generated by a heater such as a nuclear reactor core. Enhanced flow boiling CHF may provide larger safety margins and/or better economics of nuclear reactors, for example, because reactor power rating may be increased as cooling is enhanced.

### RELATED APPLICATIONS

This application claims the benefit under 35 U.S.C. § 119(e) of U.S. Provisional Patent Application Ser. No. 62/888,335, filed Aug. 16, 2019, and titled “CRITICAL HEAT FLUX (CHF) ENHANCING SURFACE TREATMENT”, which is hereby incorporated herein by reference in its entirety.

### BACKGROUND

Boiling is widely applicable to a broad range of applications, which can be as small as a computer chip, or as large as a nuclear reactor core. Heat transfer coefficient (HTC) and critical heat flux (CHF) are key figures of merit of this process; they define the efficiency and maximum heat removal rate of the boiling process, respectively.

### SUMMARY

According to aspects of the present disclosure, there is provided a method, comprising flowing a fluid over an engineered surface, heating the engineered surface, and heating the fluid with the engineered surface.

In some embodiments, flowing the fluid over the engineered surface comprises flowing the fluid over a porous layer, nanowires, or a flakes surface and heating the fluid with the engineered surface comprises heating the fluid with the porous layer, the nanowires, or the flakes surface.

In some embodiments, flowing the fluid over the engineered surface comprises flowing the fluid over a porous silica layer and heating the fluid with the engineered surface comprises heating the fluid with the porous silica layer.

In some embodiments, flowing the fluid over the engineered surface comprises flowing the fluid over zinc oxide nanowires and heating the fluid with the engineered surface comprises heating the fluid with the zinc oxide nanowires.

In some embodiments, flowing the fluid over the engineered surface comprises flowing the fluid over zirconium alloy flakes and heating the fluid with the engineered surface comprises heating the fluid with the zirconium alloy flakes.

In some embodiments, heating the fluid with the engineered surface comprises boiling the fluid with the engineered surface.

In some embodiments, heating the engineered surface comprises heating the engineered surface to about a critical heat flux.

In some embodiments, the method further comprises applying a pressure of at least about 1 bar to the fluid.

In some embodiments, the method further comprises applying a pressure of at least about 4 bars to the fluid.

In some embodiments, the method further comprises applying a pressure of at least about 2200 psia to the fluid.

In some embodiments, the method further comprises heating the engineered surface to have a critical heat flux of at least about 105% that of a plain surface.

In some embodiments, the method further comprises heating the engineered surface to have a critical heat flux of at least about 110% that of a plain surface.

In some embodiments, the method further comprises heating the engineered surface to have a critical heat flux of at least about 115% that of a plain surface.

According to aspects of the present application, there is provided a system, comprising an engineered surface, a fluid configured to be in contact with the engineered surface, a heater configured to heat the fluid with the engineered surface, and a pump configured to flow the fluid over the engineered surface.

In some embodiments, the heater comprises a nuclear reactor core.

In some embodiments, the system further comprises a pressure vessel configured to apply a pressure of at least about 4 bars to the fluid.

In some embodiments, the engineered surface comprises a porous silica layer, zinc oxide nanowires, or zirconium alloy flakes.

In some embodiments, the engineered surface comprises a porous silica layer.

In some embodiments, the porous silica layer has a thickness of about 1.8 μm and the porous silica layer comprises silica nanoparticles having a diameter of about 20 nm.

In some embodiments, the engineered surface comprises zinc oxide nanowires.

In some embodiments, diameters of the zinc oxide nanowire are about 200 nm and the lengths of the zinc oxide nanowires are about 2 μm.

In some embodiments, the engineered surface comprises zirconium alloy flakes.

In some embodiments, an apparatus comprises a nuclear reactor comprising the system.

According to aspects of the present application, there is provided an apparatus, comprising a substrate and an engineered surface disposed on the substrate, the engineered surface configured to heat a flowing fluid.

In some embodiments, the engineered surface is configured to heat a flowed fluid having a pressure above about atmospheric pressure.

In some embodiments, the engineered surface is configured to have a critical heat flux of at least about 105% that of a plain surface.

In some embodiments, the engineered surface is configured to have a critical heat flux of at least about 110% that of a plain surface.

According to aspects of the present application, there is provided a method, comprising forming an engineered surface on a substrate, the engineered surface configured to heat a flowing fluid.

In some embodiments, the engineered surface is configured to heat a flowed fluid having a pressure above about atmospheric pressure.

In some embodiments, forming the engineered surface on the substrate comprises sandblasting the substrate.

In some embodiments, sandblasting the substrate comprises sandblasting a zirconium alloy surface with approximately 50 μm Al₂O₃ particles.

In some embodiments, the engineered surface is configured to have a critical heat flux of at least about 105% that of a plain surface.

In some embodiments, the engineered surface is configured to have a critical heat flux of at least about 110% that of a plain surface.

According to aspects of the present application, there is provided a method of manufacture of a nuclear reactor comprising a first surface, a fluid configured to be in contact with the first surface, a heater configured to heat the fluid with the first surface, and a pump configured to flow the fluid over the first surface. The method comprises the steps of replacing the first surface with an engineered second surface so that the fluid is configured to be in contact with the engineered second surface, the heater is configured to heat the fluid with the engineered second surface, and the pump is configured to flow the fluid over the engineered second surface.

In some embodiments, the nuclear reactor further comprises a pressure vessel configured to apply a pressure above about atmospheric pressure to the fluid.

In some embodiments, the engineered second surface is configured to have a critical heat flux of at least about 105% that of the first surface, wherein the first surface comprises a plain surface.

In some embodiments, the engineered second surface is configured to have a critical heat flux of at least about 110% that of the first surface, wherein the first surface comprises a plain surface.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Various aspects and embodiments will be described with reference to the following figures. The figures are not necessarily drawn to scale.

FIG. 1 shows a side cross-sectional view of an illustrative system for enhancing critical heat flux on a surface in subcooled flow boiling of a nuclear reactor;

FIG. 2 shows a top cross-sectional view of components of an illustrative pressurized water reactor;

FIG. 3A is a top plan view of an illustrative scanning electron microscope (SEM) image of porous silica layer with a scale bar of 200 nm;

FIG. 3B is a side cross-sectional view of an illustrative image of a porous silica layer with a scale bar of 300 nm;

FIG. 3C shows a top perspective view of an illustrative porous silica layer;

FIG. 4A is a top plan view of an illustrative SEM image of zinc oxide nanowires with a scale bar of 20 μm;

FIG. 4B is a detail top plan view of an illustrative SEM image of the zinc oxide nanowires of FIG. 4A with a scale bar of 1 μm;

FIG. 4C shows a top perspective view of illustrative zinc oxide nanowires;

FIG. 5A is a top plan view of an illustrative SEM image of zirconium alloy flakes with a scale bar of 100 μm;

FIG. 5B is a top plan view of an illustrative SEM image of zirconium alloy flakes with a scale bar of 20 μm;

FIG. 5C is a top plan view of an illustrative SEM image of zirconium alloy flakes with a scale bar of 10 μm;

FIG. 6A shows an illustrative boiling curve on different surfaces at 1 bar;

FIG. 6B shows an illustrative boiling curve on different surfaces at 4 bar;

FIG. 7A shows a top plan view of an illustrative heat flux distribution on an ITO surface at 3.01 MW/m²;

FIG. 7B shows a top plan view of an illustrative heat flux distribution on a zinc oxide nanowire surface at 3.09 MW/m²;

FIG. 7C shows a top plan view of an illustrative heat flux distribution on a silica Layer-by-Layer (LbL) porous layer surface at 2.92 MW/m²;

FIG. 8A shows a side view of an illustrative force balance for a bubble on a plain surface;

FIG. 8B shows a side view of an illustrative force balance for a bubble rolling on plain surfaces;

FIG. 8C shows a side view of an illustrative force balance for bubble lift off on engineered surfaces;

FIG. 9A shows an illustrative curve of nucleation site density (NSD) as a function of applied heat flux at 1 bar;

FIG. 9B shows an illustrative curve of NSD as a function of applied heat flux at 4 bar;

FIG. 10A shows an illustrative curve of bubble frequency as a function of applied heat flux at 1 bar;

FIG. 10B shows an illustrative curve of bubble frequency as a function of applied heat flux at 4 bar;

FIG. 11A shows an illustrative curve of NSD as a function of wall superheat at 1 bar;

FIG. 11B shows an illustrative curve of NSD as a function of wall superheat at 4 bar;

FIG. 12A shows illustrative curves for temperature and heat flux over time for a flakes surface;

FIG. 12B shows illustrative curves for temperature and heat flux over time for a flakes surface;

FIG. 12C shows illustrative curves for temperature and heat flux over time for a flakes surface;

FIG. 12D shows illustrative curves for temperature and heat flux over time for a flakes surface;

FIG. 13A shows illustrative curves for temperature and heat flux over time for a plain surface;

FIG. 13B shows illustrative curves for temperature and heat flux over time for a plain surface;

FIG. 13C shows illustrative curves for temperature and heat flux over time for a plain surface;

FIG. 13D shows illustrative curves for temperature and heat flux over time for a plain surface;

FIG. 14 is a process flow of an illustrative method according to some embodiments;

FIG. 15 is a process flow of an illustrative method according to some embodiments; and

FIG. 16 is a process flow of an illustrative method according to some embodiments.

### DETAILED DESCRIPTION

Engineered surfaces, such as surfaces having nano- and/or micro-scale features, may provide an enhanced flow boiling Critical Heat Flux (CHF) at ambient or higher pressures, which may enhance cooling. In some embodiments, an engineered surface may comprise a surface having micro- or nano-scale features. In some embodiments, an engineered surface may comprise at least one of a porous silica layer, zinc oxide nanowires, or zirconium alloy flakes.

Enhancing flow boiling CHF may be desirable for nuclear reactors. Enhanced flow boiling CHF may imply larger safety margins and/or better economics (e.g., because reactor power rating may be increased as cooling is enhanced). The heat may be generated by a heater or a boiler, such as a nuclear reactor core. In some embodiments, engineered surfaces, such as surfaces having nano- and/or micro-scale features, may provide an enhanced pool boiling CHF. In various other embodiments, engineered surfaces with nano- and/or micro-scale features may be deployed in flow boiling conditions, at ambient or higher pressures. In some embodiments, ambient or higher pressures may comprise operating pressures of a nuclear reactor. In some embodiments, an engineered surface may be disposed in a pressure of about 1 bar, at least about 1 bar, about 4 bars at least about 4 bars, greater than about 130 bars, less than about 155 bars between about 130-155 bars, greater than about 1900 psia, less than about 2250 psia, between about 1900-2250 psia, about 2200 psia, or at least about 2200 psia. The pressure may be applied by a pressure vessel, for example, in a nuclear reactor. Fluid in flow boiling may be flowed by a pump.

Boiling is an efficient heat transfer process, and is used in heat management, e.g., in electric power stations and high-power-density electronic devices. In such systems, the boiling process dynamics is driven by the heat flux transferred from the heated surface. An increase in the heat flux produces a rise of the surface temperature, which in turn increases the bubble nucleation site density (NSD) and departure frequency. In some environments, one vulnerability of boiling may be an instability known as the boiling crisis, which may be triggered when the heat flux reaches the CHF limit. This phenomenon coincides with a sudden transition from a nucleate boiling regime, with discrete bubbles on the surface, to a film boiling regime, where a stable vapor layer blankets the entire heating surface. Such a layer may cause a drastic degradation of the heat removal process, resulting in a potentially catastrophic escalation of the heater temperature. Thus, understanding the boiling crisis, and predicting and possibly enhancing the CHF are desirable goals for the safety and economics of many thermal systems. In some embodiments, CHF may depend on fluid properties and operating conditions, heater geometry, surface material, orientation, and properties (e.g., roughness, porosity, and intrinsic wettability).

The inventors have recognized and appreciated that disposing engineered surfaces in pressurized, subcooled flow boiling conditions may have various effects on the CHF of the surface. In some embodiments, one of three engineered surfaces are provided: a surface coated with a porous layer made of hydrophilic silica nanoparticles, a surface coated with zinc oxide nanowires; or a sandblasted zirconium alloy flakes surface. Engineered surfaces may be disposed in subcooled flow boiling environments.

Subcooled flow boiling may be enhanced using engineered surfaces, such as superhydrophilic silica nano-porous layers, superhydrophilic zinc oxide nanowire surfaces, or zirconium alloy flakes surfaces. Conventional operating environments do not employ subcooled flow boiling on engineered surfaces, and may for example only be applied to pool boiling at atmospheric pressure. Measured time-dependent temperature and heat flux distributions and extracted parameters of the boiling process are such as bubble departure frequency and nucleation sited density demonstrate several enhancements.

The inventors have recognized and appreciated that engineered surfaces may enhance the flow boiling at ambient pressure as well as elevated pressure. The inventors have recognized and appreciated that the enhancement may be due to a change in the bubble dynamics. For example, superhydrophilic surfaces may provoke smaller, faster and more numerous bubbles that delay the formation of irreversible vapor patches.

The inventors have further recognized and appreciated that engineered surfaces may affect the heat transfer coefficient (HTC) by shifting the distribution of cavity size. For example, engineered surfaces may decrease the density of relatively large cavities (e.g., with μm-scale radii) at low pressures. Instead, they may increase the number of nano-scale nucleation sites at higher pressure. Accordingly, they may deteriorate and improve the heat transfer coefficient at low and high pressure, respectively.

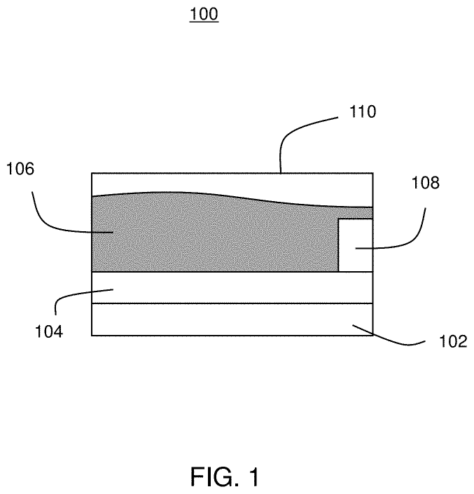

According to aspects of the present disclosure, there is provided a system for enhancing critical heat flux on a surface in subcooled flow boiling of a nuclear reactor. For example, FIG. 1 depicts such a system 100. System 100 may comprise a nuclear reactor. System 100 comprises a heater 102, an engineered surface 104, a fluid 106, a pump 108, and a pressure vessel 110.

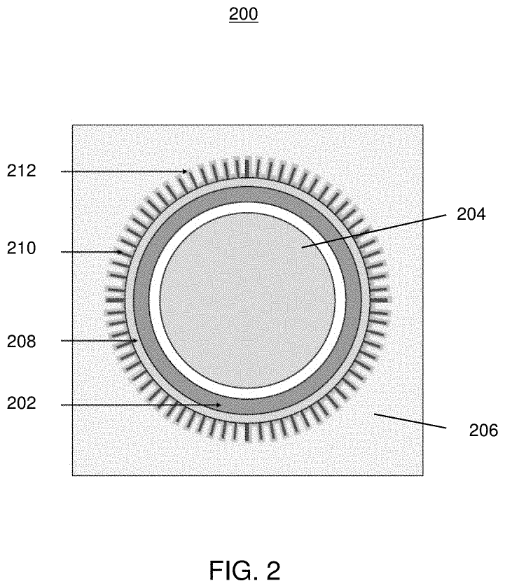

FIG. 2 shows components of an illustrative pressurized water reactor 200. For example, the components of FIG. 2 may include nuclear fuel cladding 202. The nuclear fuel cladding may contain nuclear fuel 204, e.g., nuclear fuel pellets. The nuclear fuel cladding may in turn be contained within a pressure vessel (not illustrated in FIG. 2) containing a fluid 206. In some embodiments, a proton barrier coating 208 is disposed around the cladding 202. In some embodiments, system 100 may comprise some of the components of the pressurized water reactor of FIG. 2. Accordingly, a surface of the nuclear fuel cladding of FIG. 2 that is in contact with flowing fluid may comprise an engineered surface, such as engineered surface 210. In some embodiments, a crud repellant coating 212 is disposed on engineered surface 210.

Heater 102 is configured to heat the fluid 106 using the engineered surface 104, for example, by using the engineered surface 104 as an interface. Heater 102 may comprise a nuclear reactor core or fuel. In various embodiments, the heater 102 may be configured to heat the fluid in a similar manner as other heaters herein, and/or may be configured to heat the fluid in a manner similar to a heater in a nuclear reactor well known in the art.

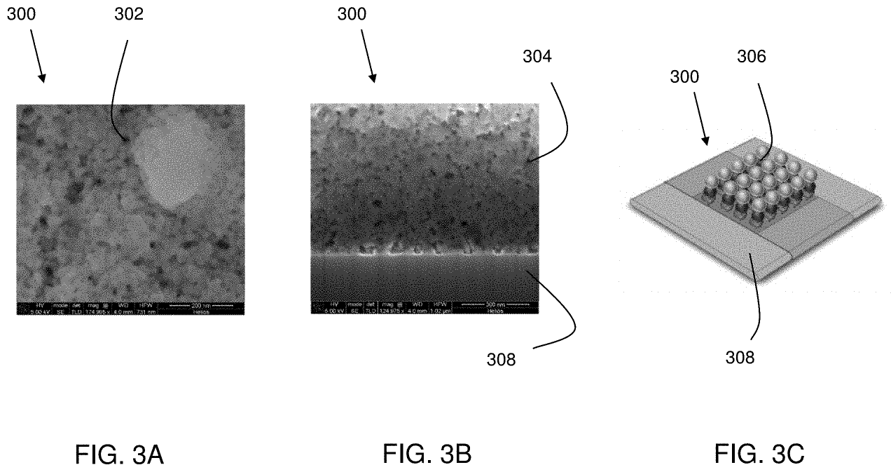

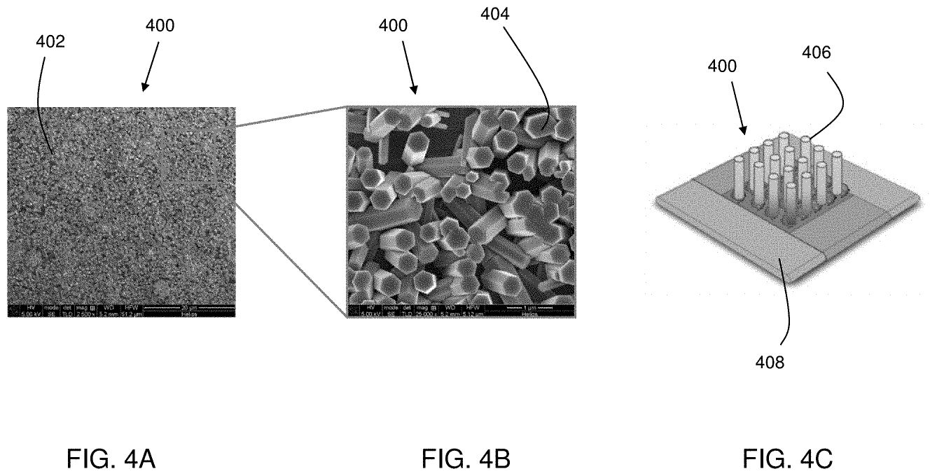

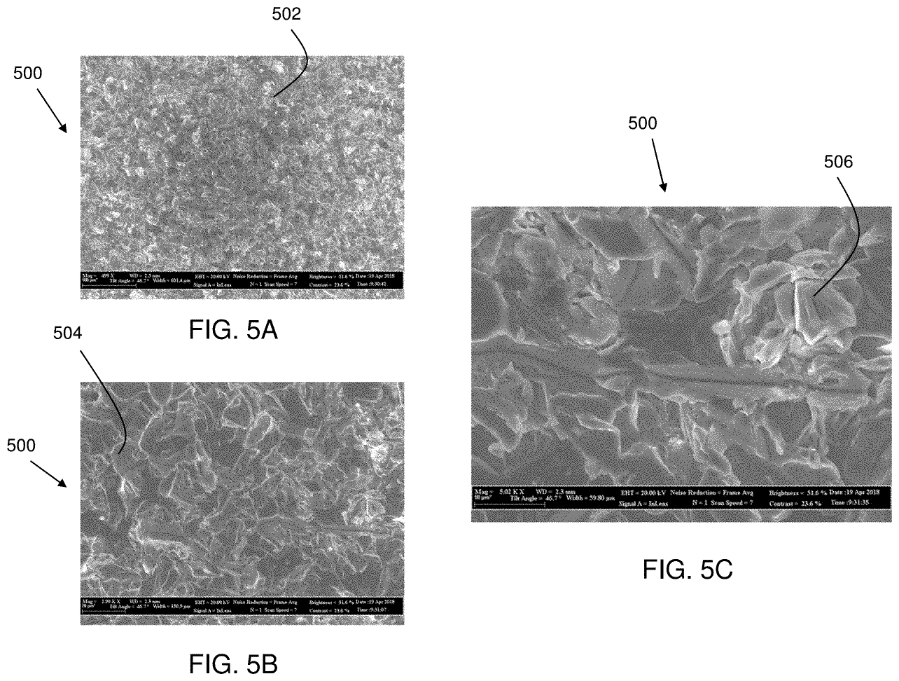

Engineered surface 104 may comprise at least one of the engineered surfaces described herein, such as with respect to FIGS. 3A-B, FIGS. 4A-B, or FIGS. 5A-C.

Fluid 106 is configured to be in contact with the engineered surface 102. In various embodiments, the fluid 106 may be configured in a similar manner as fluids described herein, and/or may be configured in a manner similar to a fluid in a nuclear reactor well known in the art.

Pump 108 is configured to flow the fluid 106 over the engineered surface 104. In various embodiments, the pump 108 may be configured to flow fluid over a surface in a similar manner as described herein, and/or may be configured in a manner similar to a pump in a nuclear reactor well known in the art. In some embodiments, pump 108 may be configured to provide natural circulation. For example, pump 108 may comprise a heater positioned lower than a cooler, where differing densities of the fluid at the heater and cooler and gravity are the driving forces of the pump.

Pressure vessel 110 is configured to apply a pressure to the fluid. In various embodiments, the pressure vessel 110 may be configured to apply pressure to fluid in a similar manner as described herein, and/or may be configured in a manner similar to a pressure vessel in a nuclear reactor well known in the art, for example, pressurized up to a pressure of at least about 160 bar.

Subcooled flow boiling experiments may be performed using engineered surfaces manufactured on an infrared (IR) heater. An IR heater enables measurements of time-dependent temperature and heat flux distributions. Fundamental length and time scales of the boiling process such as NSD, bubble growth time and wait time, and bubble footprint area may be extracted from heat flux distributions to understand the physics behind the boiling process. The inventors have recognized and appreciated that engineered surfaces have a CHF limit higher than plain surfaces. The inventors have further recognized and appreciated that, even in flow boiling conditions, engineered surfaces have a CHF limit higher than plain surfaces. At atmospheric pressure, with a mass flux of 1000 kg/m²/s and a subcooling of 10° C., the enhancement may be, for example, about 0.6 MW/m² for each coating. At 4 bars, the enhancement may be, for example, even higher, about 0.8 MW/m² for the zinc oxide nanowires, and about 1.2 MW/m² for the silica nanoparticles. The enhancement is explained through an understanding of how the engineered surfaces change the boiling process dynamics.

Superhydrophilic engineered surfaces may provide enhancement of CHF. In some embodiments, these enhancements are applied to pool boiling at atmospheric pressure. However, superhydrophilic engineered surfaces may also be disposed in pressurized pool boiling or forced flow conditions. The inventors have recognized and appreciated that forced flow may change the boiling dynamics, and engineered surfaces therefore may not have similar benefits in flow boiling, at ambient pressure or under pressurized conditions.

Special IR heaters with engineered features may be designed to test performance in pressurized flow boiling conditions. Such specially designed heaters together with advanced diagnostics and post-processing tools enable the measurements of time-dependent temperature and heat flux distributions on the boiling surface, as well as other crucial boiling parameters such as bubble frequency and NSD. Conventionally, such measurements are not taken in pressurized flow boiling conditions. The effects of engineered surfaces on flow boiling and explored the fundamental physics are discussed in more detail below.

In some embodiments, a high-pressure flow boiling loop may be implemented in taking the measurements noted above. According to one exemplary and non-limiting embodiment, subcooled flow boiling can occur at 10° C., at 1 bar or 4 bar in a flow loop. For example, a flow channel in a test section may have dimensions 3 cm×1 cm. A specially designed IR heater may be installed in a Shapal™ cartridge. To generate fully developed upward flow in the test section, an entrance region with the same flow channel dimensions and a length of about 60 hydrodynamic diameters may be installed before the test section. The mass flux in the flow channel may be set at 1000 kg/m²/s for tests. In some embodiments, based on the flow conditions and test section geometry, a Reynolds number may be greater than about 4.75×10³, less than about 4.75×10⁵, between about 4.75×10³ and about 4.75×10⁵, or about 4.75×10⁴ at a pressure of about 1 bar or may be greater than about 7.26×10³, less than about 7.26×10⁵, between about 7.26×10³ and about 7.26×10⁵, or about 7.26×10⁴ at a pressure of about 4 bar. In some embodiments, a Prandtl number may be greater than about 1.50, less than about 2.50, between about 1.50 and 2.50, or about 1.97 at a pressure of about 1 bar or greater than about 0.75, less than about 1.75, between about 0.75 and 1.75, or about 1.29 at a pressure of about 4 bar.

During a test, voltage may be applied across the heater and increased stepwise until the CHF. Increments of heat flux may be approximately 0.3 MW/m² at the beginning of the boiling curve and may reduce to approximately 0.1 MW/m² near CHF. Voltage and current may be recorded with a frequency of 10 kHz. The heater temperature may be monitored by a high-speed IR camera (IRC 806HS) with a frame rate of 2500 fps. Spatial resolution of the camera may be approximately 100 μm/pixel. Accuracy and precision of the temperature measurements may be smaller than 1.1° C. and 0.1° C., respectively. Recorded time-dependent temperature distributions may be processed with the 3D radiation-conduction model to get the heat flux distribution.

According to aspects of the present disclosure, engineered IR heaters may be fabricated. Plain IR heaters such as sapphire substrates coated with indium tin oxide (ITO), may be used in boiling conditions. In some embodiments, the ITO film is about 700 nm thick which may typically be negligible in terms of thermal resistance and thermal capacity. In some embodiments, the sapphire substrate is about 1 mm thick. This thickness may typically be enough to exclude thickness related bias of the CHF limit. An active heating area, 10 mm×10 mm, may be disposed at the center of the heater. Gold pads may provide electrical connections and define the active ITO heating area. The ITO may be opaque to IR radiation while the sapphire may be almost transparent, which enables detection of the IR signal from the back of the ITO heater while the top of it is in contact with a fluid, for example, water.

According to aspects of the present application, three types of micro- or nano-scale structures, namely nanoporous silica layer (referred to herein as LbL), zinc oxide nanowires (referred to herein as ZnO), or zirconium alloy flakes may be engineered on top of an active heating area of a plain heater. The inventors have recognized and appreciated that these three structures each show benefits in enhancing pool boiling CHF and are compatible with the above-described IR heater design.

In some embodiments, an engineered surface may comprise a porous silica surface. In some embodiments, a porous silica layer, such as porous silica layer 200 may comprise nano-scale features such as pores 302, 304, or 306. In some embodiments, a porous silica layer is fabricated by a Layer-by-Layer (LbL) technique. The inventors have recognized and appreciated that a layer having a thickness of greater than about 1.3 μm, less than about 2.3 μm, between about 1.3 μm and about 2.3 μm, or about 1.8 μm may be deposited to enhance the likelihood and/or amount of CHF enhancement. In some embodiments, the diameter of the silica nanoparticles may be greater than about 2 nm, less than about 200 nm, between about 2 nm and 200 nm, greater than about 10 nm, less than about 40 nm, between about 10 nm and about 40 nm, or about 20 nm. FIGS. 3A-B show scanning electron microscope (SEM) images and FIG. 4C shows an illustration of such a porous silica layer 300 formed on a substrate 308, including pores 302, 304, and 306.

In some embodiments, an engineered surface may comprise a zinc oxide nanowire surface. In some embodiments, a zinc oxide nanowire surface, such as zinc oxide nanowire surface 400, may comprise nano-scale features such as nanowires 402, 404, or 406. According to aspects of the present application, zinc oxide nanowires may be grown on a heated surface. In some embodiments, about 500 nm of Ti may be used instead of ITO as the heating element to make the zinc oxide structures to stick better. The diameter of the nanowire may be greater than about 20 nm, less than about 2 μm, between about 20 nm and about 2 μm, greater than about 100 nm, less than about 400 nm, between about 100 nm and about 400 nm, or about 200 nm. The length may be greater than about 200 nm, less than about 20 μm, between about 200 nm and 20 μm, greater than about 1 μm, less than about 4 μm, between about 1 μm and 4 μm, or about 2 μm. FIGS. 4A-B show SEM images of and FIG. 4C shows an illustration a zinc oxide nanowire surface 400 formed on a substrate 408, the surface comprising such nanowires, including nanowires 402, 404, and 406.

According to aspects of the present application, an engineered surface may comprise an engineered flakes surface. In some embodiments, a flakes surface may be formed on a substrate. For example, FIGS. 5A-5C show SEM images of a zirconium alloy flakes surface 500. In some embodiments, a flakes surface comprises micro-scale features, for example, flakes 502, 504, and 506. In some embodiments, flakes may comprise micro-flakes. In some embodiments, a flakes surface is formed by sandblasting a surface. For example, a flakes surface may be formed by sandblasting a zirconium alloy surface, such as a surface of Zircaloy. According to one exemplary and non-limiting embodiment, a flakes surface may be formed using Al₂O₃ nanoparticles of greater than about 5 μm, less than about 500 μm, between about 5 μm and about 500 μm, greater than about 25 μm, less than about 100 μm, between about 25 μm and about 100 μm, or about 50 μm as an abrasive. In some embodiments, an AccuFlo® MicroBlaster® sandblaster may be used with a nozzle to surface distance of about 5 in, a nozzle sweeping speed of about 4 in/s, a blasting pressure of about 120 psi, an inner diameter of nozzle of about 0.030 in and a diameter of orifice of about 0.025 in. According to one embodiment, the nozzle may be rastered over a part 16 times with an about 0.075 in step-over for each pass, using an xy linear stage to control nozzle distance and speed. In some embodiments, a flakes surface may comprise another material, for example, copper.

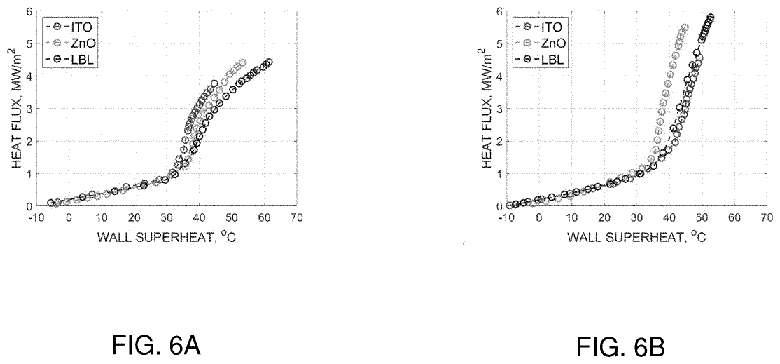

FIG. 6A shows a boiling curve for two engineered surfaces at 1 bar and FIG. 6B shows a boiling curve for two engineering surfaces at 4 bar. The boiling curve of a plain ITO heater is also plotted in each of FIG. 6A-B as a reference. In FIG. 6A, ITO is the leftmost curve, ZnO is the center curve, and LbL is the rightmost curve. In FIG. 6B, ZnO is the left most curve, LbL is the center curve, and ITO is the rightmost curve. The CHF values and corresponding enhancements are summarized in Table I. The inventors have recognized and appreciated that the porous silica and zinc oxide nanowire may enhance the flow boiling CHF at 1 bar and 4 bar. The inventors have further recognized and appreciated that the engineered surface may enhance the HTC at 4 bar and may reduce the HTC at 1 bar. Table I describes a summary of CHF on the different surfaces.

In some embodiments, at pressures at about atmospheric pressure, for example, about 1 bar, the CHF is increased at least about 10% (e.g., to at least about 4.25 MW/m²) or at least about 15% (e.g., to at least about 4.40 MW/m²) compared to the ITO. In some embodiments, at pressures above about atmospheric pressure, for example, about 4 bar, the CHF is increased at least about 10% (e.g., to at least about 5.10 MW/m²) or at least about 15% (e.g., to at least about 5.35 MW/m²) compared to the ITO.

TABLE I

| | 1 bar | | 4 bar | |
|---|---|---|---|---|
| | CHF MW/m² | Enhancement | CHF MW/m² | Enhancement |
| ITO | 3.86 ± 0.09 | | 4.65 ± 0.09 | |
| LBL | 4.46 ± 0.04 | 15.50% | 5.84 ± 0.04 | 25.60% |
| ZnO | 4.47 ± 0.06 | 15.80% | 5.42 ± 0.07 | 16.60% |

Boiling tests may be run by increasing heat flux step by step, with the last step indicated the point where CHF happens. Thus, the last data point on each boiling curve represents a last stable point before CHF. In Table I, the nominal CHF value is reported as the last stable point.

In some embodiments, a flakes surface, such as a sandblasted surface, may have a CHF that is increased by at least about 5% compared to a plain surface. For example, a flakes surface may have a CHF that is increased by at least about 5% at conditions similar to some pressurized water reactors. For example, the enhancement may occur with a system pressure of at least about 2200 psia, for example, about 2240-2250 psia, or about 2245 psia. The enhancement may occur with a chimney inlet temperature of at least about 600° F., for example, about 640-650° F., or about 645° F. The enhancement may occur at a chimney inlet flow rate of at least about 15 gpm, for example, 15.0-15.5 gpm, or about 15.3 gpm. At such conditions, a flakes surface may show a heat flux of at least about 300 W/cm², for example, about 300-320 W/cm², or about 310 W/cm², compared to about 285-295 W/cm² or about 290 W/cm² for a plain surface. In some embodiments, a Reynolds number of a flakes surface may be about 3.35×10⁵. Exemplary results for flakes surfaces compared to plain surfaces are summarized in Table II below.

TABLE II

| | System | Chimney Inlet | Chimney | Heat |
|---|---|---|---|---|
| | Pressure, | Temperature, | Inlet Flow | Flux, |
| | psia | ° F. | Rate, gpm | W/cm² |
| Flakes Surface A | 2243.0 | 647.0 | 15.4 | 303.1 |
| Flakes Surface B | 2244.9 | 645.1 | 15.1 | 304.1 |
| Flakes Surface C | 2248.8 | 644.4 | 15.3 | 321.8 |
| Flakes Surface D | 2246.6 | 645.9 | 15.3 | 319.9 |
| Plain Surface A | 2247.7 | 644.1 | 15.3 | 285.5 |
| Plain Surface B | 2243.3 | 646.6 | 15.6 | 286.9 |
| Plain Surface C | 2250.0 | 645.0 | 15.6 | 283.9 |
| Plain Surface D | 2240.9 | 645.2 | 15.6 | 293.9 |

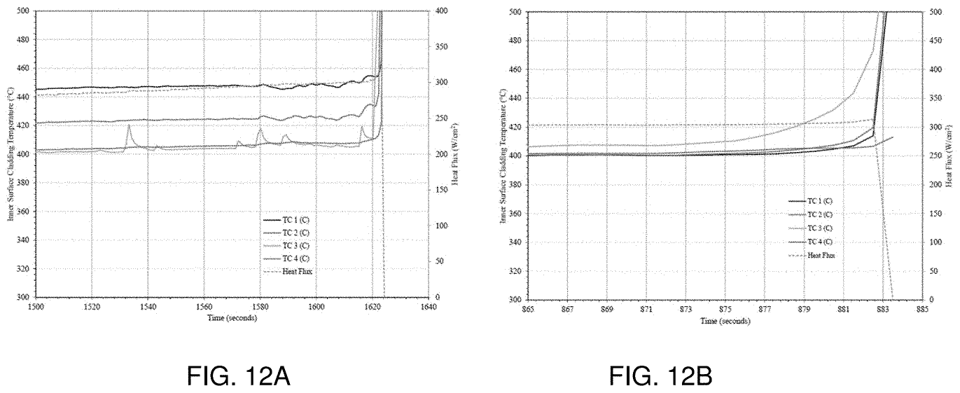

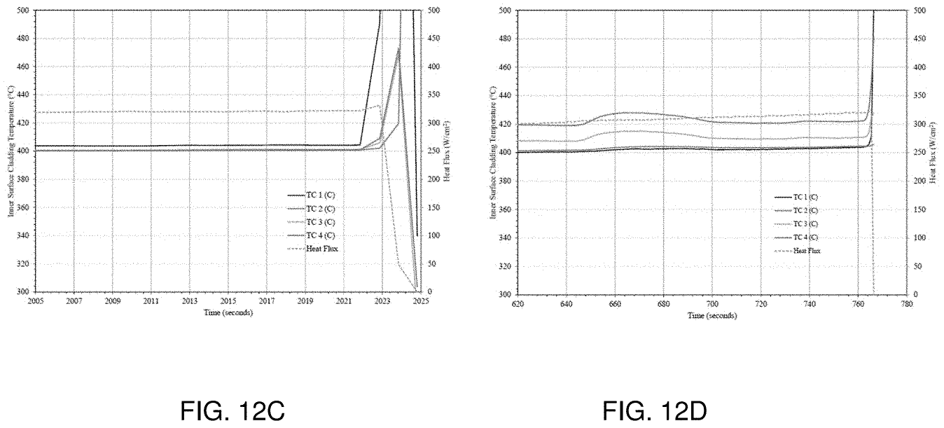

FIG. 12A shows illustrative curves for temperature and heat flux over time for flakes surface A of Table II. FIG. 12B shows illustrative curves for temperature and heat flux over time for flakes surface B of Table II. FIG. 12C shows illustrative curves for temperature and heat flux over time for flakes surface C of Table II. FIG. 12D shows illustrative curves for temperature and heat flux over time for flakes surface D of Table II.

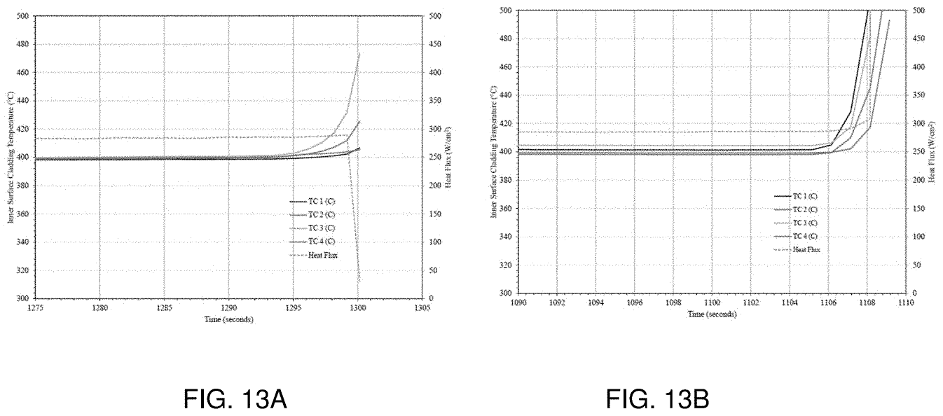

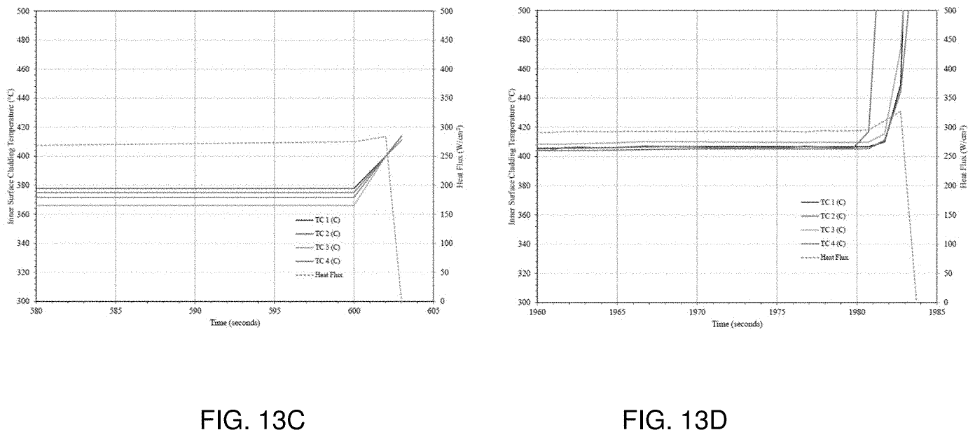

FIG. 13A shows illustrative curves for temperature and heat flux over time for plain surface A of Table II. FIG. 13B shows illustrative curves for temperature and heat flux over time for plain surface B of Table II. FIG. 13C shows illustrative curves for temperature and heat flux over time for plain surface C of Table II. FIG. 13D shows illustrative curves for temperature and heat flux over time for plain surface D of Table II.

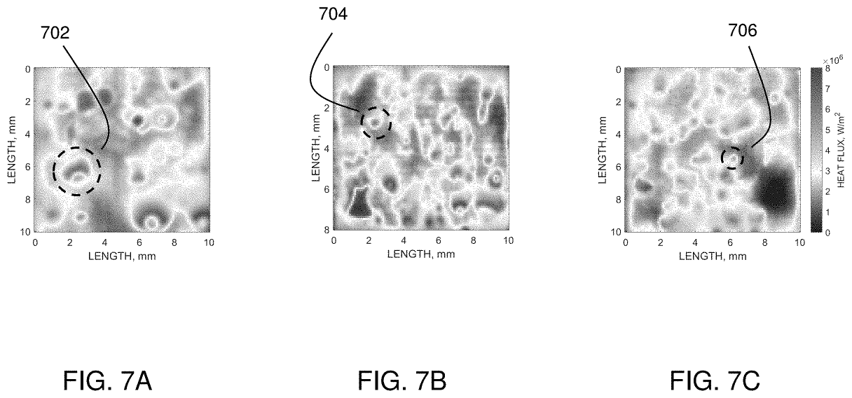

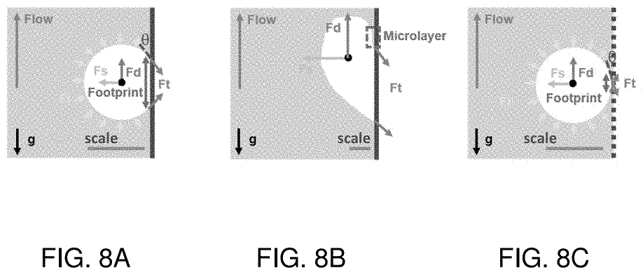

The inventors have recognized and appreciated several characteristics of engineered surfaces, such as engineered surfaces fabricated as described above, that may contribute to the enhancements discussed above. For example, the inventors have recognized and appreciated that smaller, more numerous, faster-departing bubbles observed on the engineered surfaces may be a primary reason for CHF enhancement. The inventors have recognized and appreciated that CHF may comprise a “jam of bubbles” on boiling surfaces. The inventors have recognized and appreciated that with smaller, faster-departing and more numerous bubbles, engineered surfaces can delay the formation of vapor patches and consequently enhance the critical heat flux limit. FIG. 7A shows heat flux distribution on plain ITO, FIG. 7B shows heat flux distribution on zinc oxide nanowires, and FIG. 7C shows heat flux distribution on silica nano-porous layer for the same heat flux. The red rings or spots, such as encircled at 702 in FIG. 7A, encircled at 704 in FIG. 7B, or encircled at 706 in FIG. 7C, indicate areas where the heat flux is high due to evaporation of microlayer underneath bubbles. They indicate the size of the bubble footprint. The inventors have recognized and appreciated that large bubbles are more recurrent on ITO and small bubbles are more frequent on engineered surfaces. The inventors have further recognized and appreciated that engineered surfaces may give small-size bubbles because the nano-porous hydrophilic coatings have a near-zero contact angle. This may cause pinning of the triple contact line near the nucleation site, reducing the bubble footprint radius. Accordingly, the surface tension forces that hold the bubbles attached to the surface are minimal. Consequently, the bubble departure volume may be much smaller than plain ITO surfaces. FIGS. 8A-C depict the force balance of a bubble in flow boiling conditions. When a bubble grows on a plain surface, it is subject to forces that hold it at or pull it from the surface, shown in FIG. 8A. There are detaching forces, such as the shear lift force (Fₛ), drag force and buoyancy force (F_{d}), and the contact pressure force (not illustrated in FIGS. 8A-C). The adhesion forces that hold the bubble are the inertia force (Fᵢ) and the surface tension (Fᵣ). Precisely, the surface tension is the integral along the contact line length of a sin 0, where a is the liquid-vapor surface tension, and θ is the contact angle.

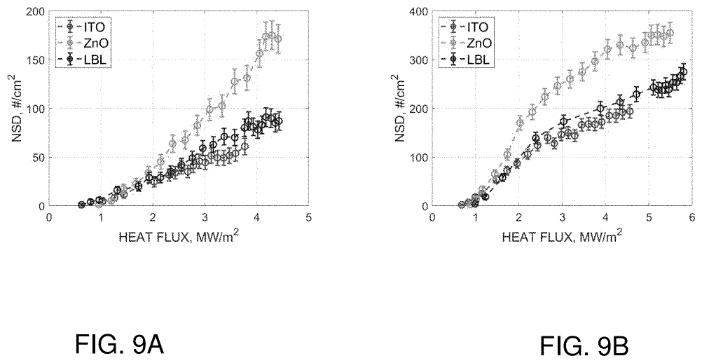

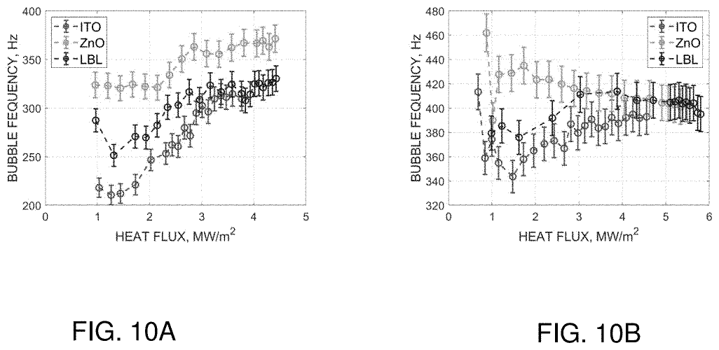

For a plain surface, e.g., ITO, the large footprint size and contact angle (about 85°) would lead to a holding force may be strong enough to overcome the shear lift force and keep the bubble attached to the wall, shown in FIG. 8A. As the bubble grows bigger, the drag and buoyancy forces push the bubble downstream, shown in FIG. 8B note the change of scale, and make it roll. This deformation generates the non-symmetric red rings in FIG. 7A, such as encircled at 702, corresponding to the evaporation of the thin liquid layer trapped between the bubble and the surface. As discussed above, for the engineered surface, shown in FIG. 8C, the contact angle is almost zero, and the bubble footprint size is very small. The holding force may be too small to balance the shear lift force; therefore, the bubble can lift off the surface even if very small. The inventors have recognized and appreciated, that as a consequence of the above, the NSD and bubble frequency on engineered surfaces may be higher than they are on ITO. The statement is supported by measurements, as shown in FIGS. 9A-B and FIGS. 10A-B.

FIG. 9A shows a curve of NSD as a function of applied heat flux at 1 bar and FIG. 9B shows a curve of NSD as a function of applied heat flux at 4 bar. In FIG. 9A, ZnO is the uppermost curve, LbL is the center curve, and ITO is the lowermost curve. In FIG. 9B, ZnO is the uppermost curve, LbL is the center curve, and ITO is the lowermost curve.

FIG. 10A shows a curve of bubble frequency as a function of applied heat flux at 1 bar and FIG. 10B shows a curve of bubble frequency as a function of applied heat flux at 4 bar. In FIG. 10A, ZnO is the uppermost curve, LbL is the center curve, and ITO is the lowermost curve. In FIG. 10B, ZnO is the uppermost curve, LbL is the center curve, and ITO is the lowermost curve.

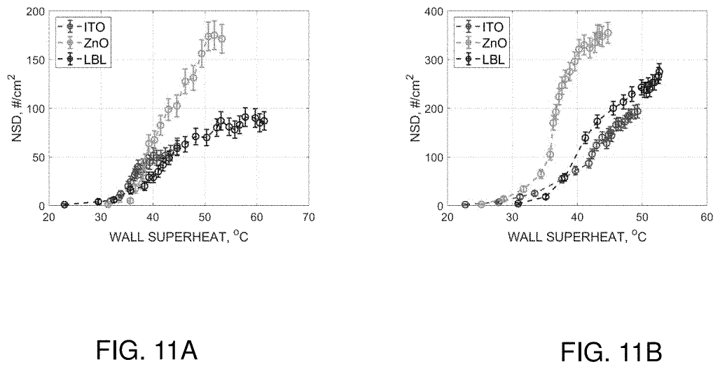

FIG. 11A shows a curve of NSD as a function of wall superheat at 1 bar and FIG. 11B shows an illustrative curve of NSD as a function of wall superheat at 4 bar. In FIG. 11A, ZnO is the curve extending uppermost, ITO is the shortest curve, and LbL is the curve extending rightmost. In FIG. 11B, ZnO is the leftmost curve, LbL is the center curve, and ITO is the rightmost curve.

The inventors have recognized and appreciated that a change in cavity size distribution may be the reason for the different effects of nano structures on HTC at 1 bar and 4 bar. FIGS. 11A-B show the NSD at the two pressures. At 1 bar, the ITO surface starts to nucleate earlier. According to some classical nucleation models, the superheat (ΔTₛₐₜ) required to nucleate a cavity is inversely proportional to its size shown below in Equation 1:

rₑ˜(2σTₛₐₜ)/(μ_{g}hₗₐₜΔTₛₐₜ) Equation 1:

Therefore, at relatively low superheats, large cavities will nucleate first. From the onset of nucleation in FIG. 11 the onset of nucleate boiling (ONB) cavity size on ITO may be estimated to be about 1 μm. From the SEM images, FIGS. 4A-B and FIGS. 5A-B, it can be seen that the features on the engineered surfaces are generally less than about 500 nm. When the porous silica layer and zinc oxide nanowires cover the plain surfaces, they will fill some of the large cavities and create many small cavities. As a result, the engineered surfaces do not have sufficient large cavities to nucleate at low superheats. However, FIGS. 11A-B do show that as the wall superheat increases, the engineered surface nucleates more than ITO, i.e., the rate of growth of the NSD is higher. That happens because the coatings create many small-size imperfections in the range of the active cavity size (see Equation 1). At 4 bar, the scenario is different. At 1 bar, when the wall superheat is about 30° C., cavities larger than about 1 μm can be activated. For the same wall superheat, at 4 bar, all cavities larger than about 300 nm can nucleate. While the engineered surfaces may not have many cavities larger than about 1 μm, they have more cavities around about 300 nm than the plain ITO. Thus, at 4 bar, the engineered surfaces have a higher NSD since the onset of nucleate boiling, shown in FIG. 11B. That supports the enhancement of boiling heat transfer coefficient at high pressure.

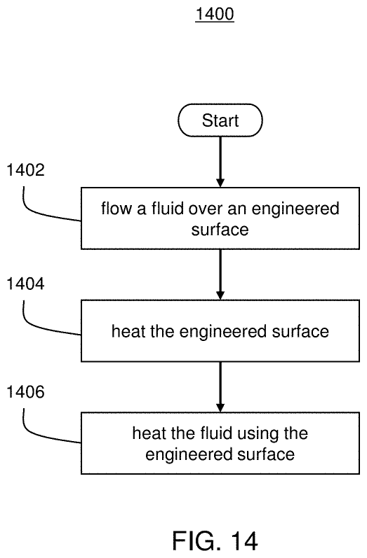

FIG. 14 is a process flow of an illustrative method according to some embodiments. Process 1400 includes step 1402, step 1404, and step 1406. Step 1402 comprises flowing a fluid over a engineered surface. Step 1404 comprises heating the engineered surface. Step 1406 comprises heating the fluid using the engineered surface. At least some of the steps of process 1400 may be performed substantially simultaneously.

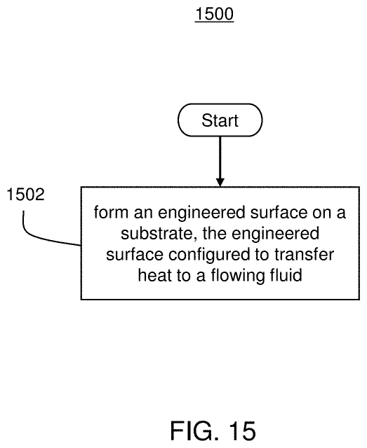

FIG. 15 is a process flow of an illustrative method according to some embodiments. Process 1500 includes step 1502. Step 1502 comprises forming a engineered surface on a substrate, the engineered surface configured to transfer heat to a flowing fluid.

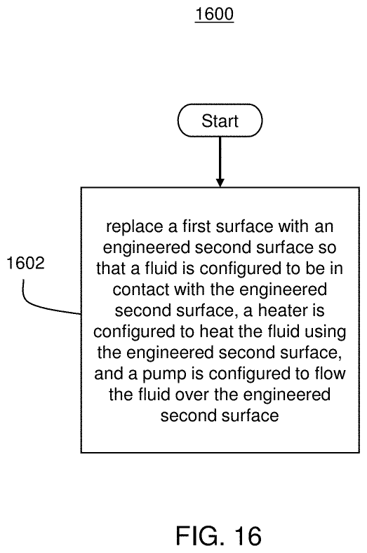

In some embodiments, a previously-installed plain surface in a nuclear reactor may be replaced by the nano-engineered surface. In other embodiments, a previously-installed plain surface in a nuclear reactor may be removed from the nuclear reactor, have an engineered surface formed thereon, and be replaced into the nuclear reactor. FIG. 16 is a process flow of an illustrative method according to some embodiments. Process 1600 includes step 1602. Step 1602 comprises replacing a first surface with a engineered second surface so that a fluid is configured to be in contact with the engineered second surface, a heater is configured to heat the fluid using the engineered second surface, and a pump configured to flow the fluid over the engineered second surface.

Various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In view of the described embodiments of the techniques described herein and variations thereof, below are described certain more particularly described aspects. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A method, comprising: flowing a fluid over an engineered surface; heating the engineered surface; and heating the fluid with the engineered surface.

Aspect 2: The method of aspect 1, wherein flowing the fluid over the engineered surface comprises flowing the fluid over a porous layer, nanowires, or a flakes surface and heating the fluid with the engineered surface comprises heating the fluid with the porous layer, the nanowires, or the flakes surface.

Aspect 3: The method of any one of the preceding aspects, wherein flowing the fluid over the engineered surface comprises flowing the fluid over a porous silica layer and heating the fluid with the engineered surface comprises heating the fluid with the porous silica layer.

Aspect 5: The method of any one of the preceding aspects, wherein flowing the fluid over the engineered surface comprises flowing the fluid over zinc oxide nanowires and heating the fluid with the engineered surface comprises heating the fluid with the zinc oxide nanowires.

Aspect 5: The method of any one of the preceding aspects, wherein flowing the fluid over the engineered surface comprises flowing the fluid over zirconium alloy flakes and heating the fluid with the engineered surface comprises heating the fluid with the zirconium alloy flakes.

Aspect 6: The method of any one of the preceding aspects, wherein heating the engineered surface comprises heating the engineered surface to about a critical heat flux.

Aspect 7: The method of any one of the preceding aspects, further comprising applying a pressure of at least about 4 bars to the fluid.

Aspect 8: The method of any one of the preceding aspects, further comprising applying a pressure of at least about 2200 psia to the fluid.

Aspect 9: The method of any one of the preceding aspects, further comprising heating the engineered surface to have a critical heat flux of at least about 105% that of a plain surface.

Aspect 10: A system, comprising: an engineered surface; a fluid configured to be in contact with the engineered surface; a heater configured to heat the fluid with the engineered surface; and a pump configured to flow the fluid over the engineered surface.

Aspect 11: The system of aspect 10, wherein the heater comprises a nuclear reactor core. Aspect 12: The system of any one of the preceding aspects, further comprising a pressure vessel configured to apply a pressure of at least about 4 bars to the fluid.

Aspect 13: The system of any one of the preceding aspects, wherein the engineered surface comprises a porous silica layer, zinc oxide nanowires, or zirconium alloy flakes.

Aspect 14: The system of any one of the preceding aspects, wherein the engineered surface comprises a porous silica layer.

Aspect 15: The system of aspect 14, wherein the porous silica layer has a thickness of about 1.8 μm and the porous silica layer comprises silica nanoparticles having a diameter of about 20 nm.

Aspect 16: The system of any one of the preceding aspects, wherein the engineered surface comprises zinc oxide nanowires.

Aspect 17: The system of aspect 16, wherein diameters of the zinc oxide nanowire are about 200 nm and the lengths of the zinc oxide nanowires are about 2 μm.

Aspect 18: The system of any one of the preceding aspects, wherein the engineered surface comprises zirconium alloy flakes.

Aspect 19: An apparatus, comprising a nuclear reactor comprising the system of any one of aspects 10-18.

Aspect 20: An apparatus, comprising: a substrate; and an engineered surface disposed on the substrate, the engineered surface configured to transfer heat to a flowing fluid.

Aspect 21: The apparatus of aspect 20, wherein the engineered surface is configured to transfer heat to a flowed fluid having a pressure above about atmospheric pressure.

Aspect 22: The apparatus of aspect 20 or 21, wherein the engineered surface is configured to have a critical heat flux of at least about 105% that of a plain surface.

Aspect 23: A method, comprising forming a engineered surface on a substrate, the engineered surface configured to transfer heat to a flowing fluid.

Aspect 24: The method of aspect 23, wherein forming the engineered surface on the substrate comprises sandblasting the substrate.

Aspect 25: The method of aspect 24, wherein sandblasting the substrate comprises sandblasting a zirconium alloy surface with approximately 50 μm Al₂O₃ particles.

Aspect 26: The method of aspect 23 or 24, wherein the engineered surface is configured to have a critical heat flux of at least about 105% that of a plain surface.

Aspect 27: A method of manufacture of a nuclear reactor comprising a first surface, a fluid configured to be in contact with the first surface, a heater configured to heat the fluid with the first surface, and a pump configured to flow the fluid over the first surface, comprising the steps of: replacing the first surface with an engineered second surface so that the fluid is configured to be in contact with the engineered second surface, the heater is configured to heat the fluid with the engineered second surface, and the pump is configured to flow the fluid over the engineered second surface.

Aspect 28: The method of aspect 27, wherein the nuclear reactor further comprises a pressure vessel configured to apply a pressure above about atmospheric pressure to the fluid.

Aspect 29: The method of aspect 27 or 28, wherein the engineered second surface is configured to have a critical heat flux of at least about 105% that of the first surface, wherein the first surface comprises a plain surface.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method, comprising:
flowing a fluid over an engineered surface;
heating the engineered surface; and
heating the fluid with the engineered surface.

2. The method of claim 1, wherein flowing the fluid over the engineered surface comprises flowing the fluid over a porous layer, nanowires, or a flakes surface and heating the fluid with the engineered surface comprises heating the fluid with the porous layer, the nanowires, or the flakes surface.

3. The method of claim 1, wherein flowing the fluid over the engineered surface comprises flowing the fluid over a porous silica layer and heating the fluid with the engineered surface comprises heating the fluid with the porous silica layer.

4. The method of claim 1, wherein flowing the fluid over the engineered surface comprises flowing the fluid over zinc oxide nanowires and heating the fluid with the engineered surface comprises heating the fluid with the zinc oxide nanowires.

5. The method of claim 1, wherein flowing the fluid over the engineered surface comprises flowing the fluid over zirconium alloy flakes and heating the fluid with the engineered surface comprises heating the fluid with the zirconium alloy flakes.

6. The method of claim 1, wherein heating the engineered surface comprises heating the engineered surface to about a critical heat flux.

7. The method of claim 1, further comprising applying a pressure of at least about 4 bars to the fluid.

8. The method of claim 1, further comprising applying a pressure of at least about 2200 psia to the fluid.

9. The method of claim 1, further comprising heating the engineered surface to have a critical heat flux of at least about 105% that of a plain surface.

10. A system, comprising:
an engineered surface;
a fluid configured to be in contact with the engineered surface;
a heater configured to heat the fluid with the engineered surface; and
a pump configured to flow the fluid over the engineered surface.

11. The system of claim 10, wherein the heater comprises a nuclear reactor core.

12. The system of claim 10, further comprising a pressure vessel configured to apply a pressure of at least about 4 bars to the fluid.

13. The system of claim 10, wherein the engineered surface comprises a porous silica layer, zinc oxide nanowires, or zirconium alloy flakes.

14. The system of claim 10, wherein the engineered surface comprises a porous silica layer.

15. The system of claim 14, wherein the porous silica layer has a thickness of about 1.8 μm and the porous silica layer comprises silica nanoparticles having a diameter of about 20 nm.

16. The system of claim 10, wherein the engineered surface comprises zinc oxide nanowires.

17. The system of claim 16, wherein diameters of the zinc oxide nanowire are about 200 nm and the lengths of the zinc oxide nanowires are about 2 μm.

18. The system of claim 10, wherein the engineered surface comprises zirconium alloy flakes.

19. An apparatus, comprising a nuclear reactor comprising the system of claim 10.

20. An apparatus, comprising:
a substrate; and
an engineered surface disposed on the substrate, the engineered surface configured to transfer heat to a flowing fluid.

21. The apparatus of claim 20, wherein the engineered surface is configured to transfer heat to a flowed fluid having a pressure above about atmospheric pressure.

22. The apparatus of claim 20, wherein the engineered surface is configured to have a critical heat flux of at least about 105% that of a plain surface.

23. A method, comprising forming a engineered surface on a substrate, the engineered surface configured to transfer heat to a flowing fluid.

24. The method of claim 23, wherein forming the engineered surface on the substrate comprises sandblasting the substrate.

25. The method of claim 24, wherein sandblasting the substrate comprises sandblasting a zirconium alloy surface with approximately 50 μm Al₂O₃ particles.

26. The method of claim 23, wherein the engineered surface is configured to have a critical heat flux of at least about 105% that of a plain surface.

27. A method of manufacture of a nuclear reactor comprising a first surface, a fluid configured to be in contact with the first surface, a heater configured to heat the fluid with the first surface, and a pump configured to flow the fluid over the first surface, comprising the steps of:
replacing the first surface with an engineered second surface so that the fluid is configured to be in contact with the engineered second surface, the heater is configured to heat the fluid with the engineered second surface, and the pump is configured to flow the fluid over the engineered second surface.

28. The method of claim 27, wherein the nuclear reactor further comprises a pressure vessel configured to apply a pressure above about atmospheric pressure to the fluid.

29. The method of claim 27, wherein the engineered second surface is configured to have a critical heat flux of at least about 105% that of the first surface, wherein the first surface comprises a plain surface.
